(19) United States
(12) Patent Application Publication
(10) Pub. No.: US 2004/0086031 A1
(43) Pub. Date: May 6, 2004

(54) Communication transceiver module

(75) Inventor: Shohei Moriwaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/426,880

(22) Filed: May 1, 2003

(30) Foreign Application Priority Data
Oct. 30, 2002 (JP) 2002-316028

(51) Int. Cl. H04L 5/16; H04B 1/38

(52) U.S. Cl. 375/219

(57) ABSTRACT

A transceiver IC (1a) and peripheral ICs (4, 5) are mounted on a board (100). A clock generating circuit (2) such as a ring oscillator and a frequency divider (3) connected to the clock generating circuit (2) are formed in the transceiver IC (1a). The clock generating circuit (2) generates a first clock (C1) of a predetermined frequency of about several hundred megahertz. The transceiver IC (1a) operates in response to the first clock (C1). The first clock (C1) is divided down to a frequency of about several tens megahertz by the frequency divider (3) and is supplied to the peripheral IC (4) as a second clock (C2). The peripheral IC (4) operates in response to the second clock (C2).

### BACKGROUND OF THE INVENTION

1. Field of the Invention

The present invention relates to a communication transceiver module.

2. Description of the Background Art

Devices constituting a LAN (local area network) include a transmission line, a LAN board plugged into a personal computer (hereinafter referred to as “PC”), a connection cable connected to the LAN board, a cable connecting device (SEDES transceiver) for connecting the transmission line and connection cable, and the like. A transceiver is communication equipment for converting a signal supplied from a PC into a signal suitable for transmission media, and vice versa.

In a conventional transceiver module, a transceiver IC having communications capabilities, an IC provided in the periphery of the transceiver IC (hereinafter referred to as “peripheral IC”) for controlling the transceiver IC and a clock generating circuit for generating a clock to be supplied to the peripheral IC are mounted on a board.

A technique related to a communication adaptor for connecting an arithmetic unit and an analog telephone network is described in Japanese Unexamined Publication No. 9-506721 (PCT International Publication No. WO94/27399).

The above-described conventional transceiver module, however, has a large number of components mounted on the board, thus disadvantageously increasing the mounting area.

### SUMMARY OF THE INVENTION

An object of the present invention is to provide a transceiver module capable of achieving reduction in the number of components mounted on a board, thereby reducing the mounting area.

According to the present invention, the transceiver module includes a board, a transceiver IC and a peripheral IC. The transceiver IC is mounted on the board and configured to operate in response to a first clock. The peripheral IC is mounted on the board, connected to the transceiver IC and configured to operate in response to a second clock. A clock generating circuit configured to generate the first clock and a frequency divider connected to the clock generating circuit are formed in the transceiver IC. The first clock generated by the clock generating circuit is divided down by the frequency divider, to be supplied to the peripheral IC as the second clock.

The clock generating circuit and frequency divider are formed in the transceiver IC. The clock generated by the clock generating circuit is divided down by the frequency divider and is supplied to the peripheral IC as the second clock. This eliminates the need to mount a clock generating circuit for generating a clock to be supplied to the peripheral IC on the board except for the clock generating circuit formed in the transceiver IC. As a result, the number of components mounted on the board can be reduced, thus achieving reduction in the mounting area.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating the configuration of a transceiver module according to a first preferred embodiment of the present invention;

FIG. 2 is a block diagram illustrating the configuration of a transceiver module according to a second preferred embodiment of the present invention;

FIG. 3 is a block diagram illustrating a frequency divider according to the second preferred embodiment;

FIG. 4 is a block diagram illustrating the configuration of a transceiver module according to a third preferred embodiment of the present invention;

FIG. 5 is a block diagram illustrating the configuration of a frequency divider according to the third preferred embodiment;

FIG. 6 is a block diagram illustrating the configuration of a transceiver module according to a fourth preferred embodiment of the present invention; and

FIG. 7 is a block diagram illustrating a variation of the transceiver module according to the fourth preferred embodiment.

### DESCRIPTION OF THE PREFERRED EMBODIMENTS

First Preferred Embodiment

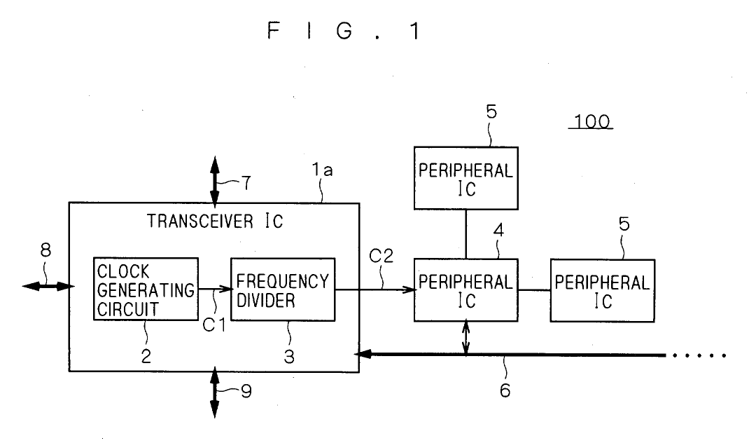

FIG. 1 is a block diagram illustrating the configuration of a transceiver module according to a first preferred embodiment of the present invention. A transceiver IC 1a having communications capabilities, a peripheral IC 4 such as MCU or ASIC and peripheral ICs 5 connected to the peripheral IC 4 are mounted on a board 100. The peripheral IC 4 is responsible for main control and the peripheral ICs 5 serve as auxiliary to the peripheral IC 4. Formed in the transceiver IC 1a are a clock generating circuit 2 such as a ring oscillator and a frequency divider 3 connected to the clock generating circuit 2 as well as a circuit (not shown) intended for achieving the communications capabilities of the transceiver IC 1a.

Connected to the transceiver IC 1a are: a control bus 6 for transmitting a control signal or the like to/from the peripheral IC 4; an internal data bus 7 for transmitting communication data to/from an upper layer (a controller for controlling a plurality of transceiver ICs); a control bus 8 for transmitting a control signal or the like to/from the upper layer; and an external data bus 9 for transmitting communication data to/from a LAN cable or the like. The control bus 6 is also connected to the peripheral IC 4.

The clock generating circuit 2 generates a clock C1 of a predetermined frequency of about several hundred megahertz. The transceiver IC 1a operates in response to the clock C1. The clock C1 generated by the clock generating circuit 2 is divided down to a frequency of about several tens megahertz by the frequency divider 3, to be supplied to the peripheral IC 4 as a clock C2. The peripheral IC 4 operates in response to the clock C2.

According to the above-described transceiver module of the present embodiment, the frequency divider 3 is formed in the transceiver IC 1a as well as the clock generating circuit 2 inherently necessary for the operation of the transceiver IC 1a, and the clock C1 generated by the clock generating circuit 2 is divided down by the frequency divider 3, to be supplied to the peripheral IC 4 as the clock C2. This eliminates the need to mount a clock generating circuit for generating a clock to be supplied to the peripheral IC 4 on the board 100 except for the clock generating circuit 2 formed in the transceiver IC 1a. As a result, the number of components mounted on the board 100 can be reduced as compared to the conventional transceiver module, thus achieving reduction in the mounting area.

Second Preferred Embodiment

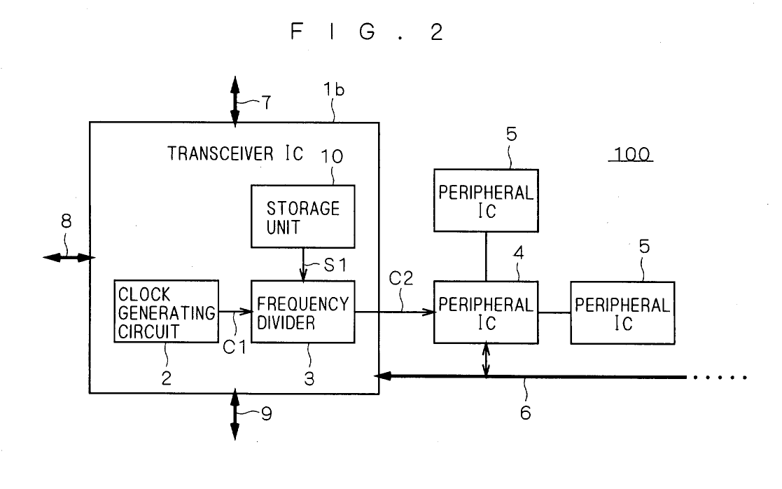

FIG. 2 is a block diagram illustrating the configuration of a transceiver module according to a second preferred embodiment of the present invention. A storage unit 10 such as a memory or resistor connected to the frequency divider 3 is formed in a transceiver IC 1b. Except for this part, the transceiver IC 1b of the present embodiment has the same configuration as the transceiver IC 1a of the first preferred embodiment. A value S1 for setting a divisional value at the frequency divider 3 is stored in the storage unit 10. The frequency divider 3 changes the divisional value in response to the value S1 stored in the storage unit 10, thus making the frequency of the clock C2 variable.

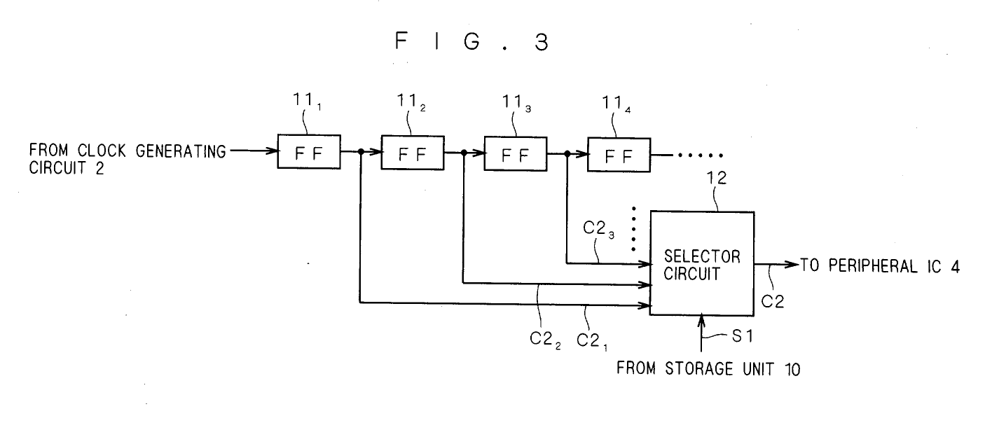

FIG. 3 is a block diagram illustrating the configuration of the frequency divider 3 according to the present embodiment. A plurality of flip flops (FFs) 11₁ to 11ₙ (n is a natural number not less than 2) are connected in series. The FFs 11₁ to 11ₙ each have an output connected to an input of the next stage FF and also connected to an input of a selector circuit 12. Thus, clocks C2₁ to C2ₙ of various frequencies are inputted to the selector circuit 12 from the FFs 11₁ to 11ₙ. The selector circuit 12 selects one of the plurality of clocks C2₁ to C2ₙ in response to the value S1 stored in the storage unit 10 and outputs the selected clock as the clock C2.

According to the above-described transceiver module of the present embodiment, the frequency of the clock C2 is variable. Thus, even when the peripheral IC 4 is replaced by a new one, rewriting the value S1 stored in the storage unit 10 allows the clock C2 to be supplied in correspondence with the operating frequency of the new peripheral IC 4.

Third Preferred Embodiment

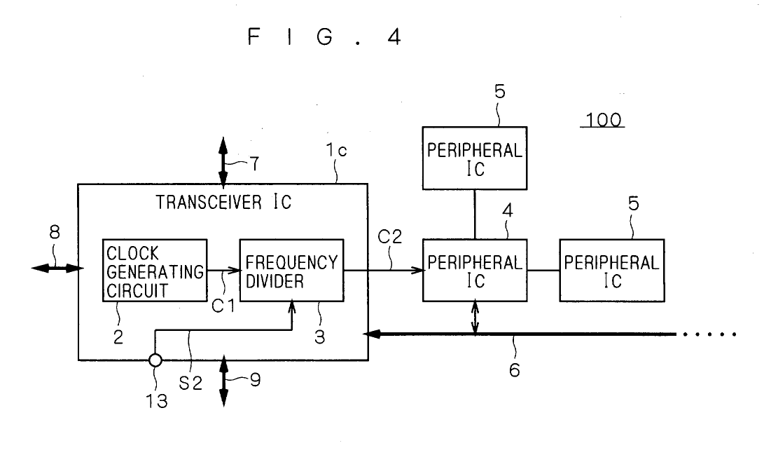

FIG. 4 is a block diagram illustrating the configuration of a transceiver module according to a third preferred embodiment of the present invention. A transceiver IC 1c has a terminal 13 connected to the frequency divider 3. Except for this part, the transceiver IC 1c of the present embodiment has the same configuration as the transceiver IC 1a of the first preferred embodiment. The terminal 13 is terminated by pull-up or pull-down. The frequency divider 3 changes the divisional value in response to a setting signal S2 indicative of conditions of the terminal 13. That is, the frequency divider 3 changes the divisional value in response to the setting signal S2 externally inputted to the transceiver IC 1c through the terminal 13, thus making the frequency of the clock C2 variable.

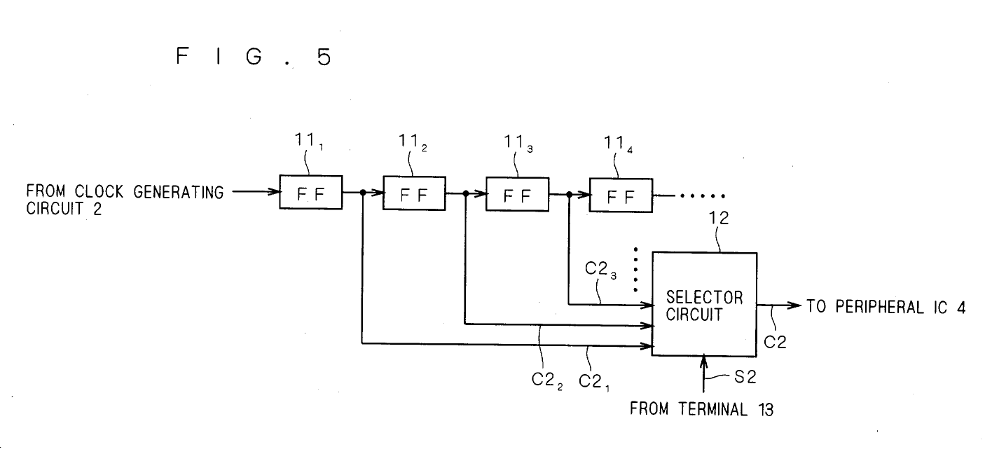

FIG. 5 is a block diagram illustrating the configuration of the frequency divider 3 according to the present embodiment. As in the second preferred embodiment, the clocks C2₁ to C2ₙ of various frequencies are inputted to the selector circuit 12 from the FFs 11₁ to 11 ₙ. The selector circuit 12 selects one of the plurality of clocks C2₁ to C2ₙ in response to the signal S2 inputted through the terminal 13 and outputs the selected clock as the clock C2.

According to the transceiver module of the present embodiment, the frequency of the clock C2 is variable. Thus, even when the peripheral IC 4 is replaced by a new one, changing the setting signal S2 inputted through the terminal 13 allows the clock C2 to be supplied in correspondence with the operating frequency of the new peripheral IC 4.

Fourth Preferred Embodiment

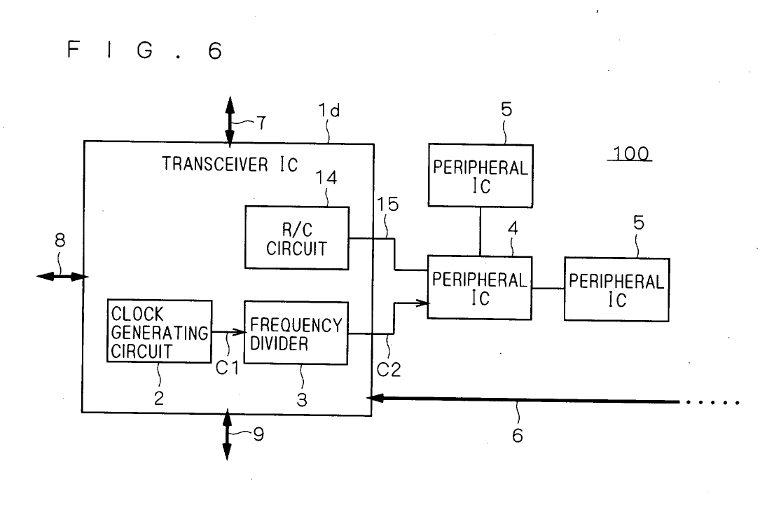

FIG. 6 is a circuit diagram illustrating the configuration of a transceiver module according to a fourth preferred embodiment of the present invention. The peripheral IC 4 has the function of performing an RC oscillation mode through the use of an auxiliary circuit (R/C circuit) 14 having a resistor and capacitor as well as a mode of receiving the clock C2 externally applied (from a transceiver IC 1d in the present embodiment). The R/C circuit 14 is connected to the peripheral IC 4 through a signal line 15. The R/C circuit 14 is not mounted on the board 100 but is formed in the transceiver IC 1d. When set in the R/C oscillation mode, the peripheral IC 4 operates in response to a clock generated by the R/C circuit 14. Except for this part, the transceiver IC 1d of the present embodiment has the same configuration as the transceiver IC 1a of the first preferred embodiment.

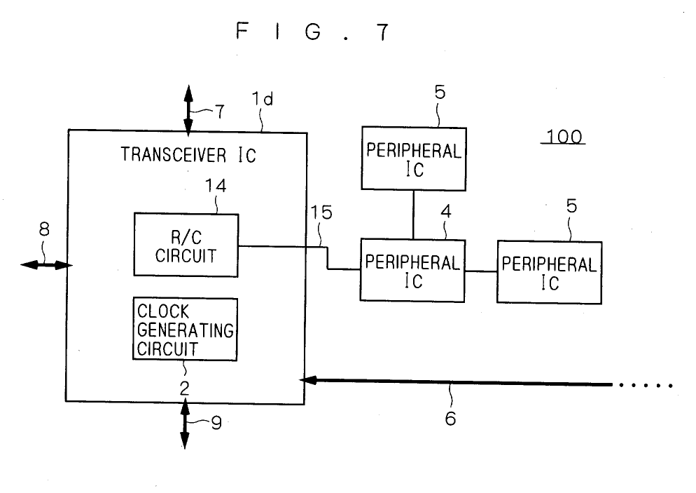

FIG. 7 is a block diagram illustrating a variation of the transceiver module according to the present embodiment. When the R/C oscillation mode needs only be used, rather than when either the mode that the peripheral IC 4 receives the clock C2 from the transceiver IC 1d and the R/C oscillation mode is selectively used, the frequency divider 3 shown in FIG. 6 may be omitted as shown in FIG. 7.

According to the transceiver module of the present embodiment, the R/C circuit 14 necessary for performing the R/C oscillation mode is formed in the transceiver IC 1d. This eliminates the need to mount the R/C circuit 14 on the board 100, whereby the number of components mounted on the board 100 can be reduced, thus achieving reduction in the mounting area.

While the invention has been shown and described in detail, the foregoing description is in all aspects illustrative and not restrictive. It is therefore understood that numerous modifications and variations can be devised without departing from the scope of the invention.

What is claimed is:

1. A transceiver module comprising:
a board;
a transceiver IC mounted on said board, configured to operate in response to a first clock; and
a peripheral IC mounted on said board, connected to said transceiver IC, configured to operate in response to a second clock, wherein
a clock generating circuit configured to generate said first clock and a frequency divider connected to said clock generating circuit are formed in said transceiver IC, and
said first clock generated by said clock generating circuit is divided down by said frequency divider, to be supplied to said peripheral IC as said second clock.

2. The transceiver module according to claim 1, wherein said frequency divider has a variable divisional value.

3. The transceiver module according to claim 2, wherein
a storage unit connected to said frequency divider is further formed in said transceiver IC, and
said frequency divider changes said divisional value in response to a value stored in said storage unit.

4. The transceiver module according to claim 2, wherein
said transceiver IC includes a certain terminal, and
said frequency divider changes said divisional value in response to a setting signal externally inputted to said transceiver IC through said certain terminal.

5. The transceiver module according to claim 1, wherein
said peripheral IC has a function of performing a predetermined oscillation mode using an auxiliary circuit externally connected to said peripheral IC, and
said auxiliary circuit is formed in said transceiver IC.
